(19) United States
(12) Patent Application Publication
(10) Pub. No.: US 2020/0394744 A1
(43) Pub. Date: Dec. 17, 2020

(54) METHOD AND SYSTEM FOR PREDICTING A PORT-STAY DURATION OF A VESSEL AT A PORT

(71) Applicant: Agency for Science, Technology and Research, Singapore (SG)

(72) Inventors: Haiyan Xu, Singapore (SG); Xiuju Fu, Singapore (SG); Xiao Feng Yin, Singapore (SG); Siow Mong Rick Goh, Singapore (SG); Wanbing Zhang, Singapore (SG)

(21) Appl. No.: 16/968,394

(22) PCT Filed: Mar. 28, 2019
(86) PCT No.: PCT/SG2019/050173

§ 371 Date: Aug. 7, 2020

(30) Foreign Application Priority Data
Mar. 28, 2018 (SG) 10201802595Y

(51) Int. Cl. G06Q 50/28; G06N 5/02; G06N 5/04; G06Q 10/04; B63B 79/20; B63B 79/40

(52) U.S. Cl. CPC G06Q 50/28; G06N 5/02; B63B 79/40; G06Q 10/04; B63B 79/20; G06N 5/04

(57) ABSTRACT

There is provided a method for predicting a port-stay duration of a vessel at a port. The method includes: determining a plurality of port-stay components of the port-stay duration; determining a regression sequence of the plurality of port-stay components, comprising modeling a first port-stay component and each of a plurality of second port-stay components, determining the regression sequence of the plurality of port-stay components based on a relative measure associated to each of the plurality of second port-stay components; modeling each of the plurality of port-stay components in sequence in accordance with the regression sequence determined to obtain a first plurality of sequentially modeled port-stay components; modeling a first port-stay duration based on the first plurality of sequentially modeled port-stay components to obtain a first port-stay duration model; and predicting the port-stay duration based on the first port-stay duration model.

### CROSS-REFERENCE TO RELATED APPLICATION

This application claims the benefit of priority of Singapore Patent Application No. 10201802595Y, filed 28 Mar. 2018, the content of which being hereby incorporated by reference in its entirety for all purposes.

### TECHNICAL FIELD

The present invention generally relates to a method and a system for predicting a port-stay duration of a vessel at a port.

### BACKGROUND

Many multi-purpose port operators worldwide face challenges caused by increasing demands and limited dedicated resources in ports including manpower, equipment, facilities, etc. The efficiency and effectiveness of port resource planning and berth allocation heavily relies on the accurate estimation of the port-stay time or duration of vessels.

Various factors and/or components affect port operation and in turn port-stay duration of vessels at a port. In most cases, the various factors and/or components affecting port-stay duration of vessels include uncertainties. For example, for ports receiving and handling general and bulk cargos, the performance and efficiency of the port operation may be affected by suspension of loading/unloading operation of cargos such as cement cargos during wet weather. Other components affecting performance and efficiency of the port operation, for example, include stevedores with different skill levels and efficiency which are deployed for trimming operations at the port. Such factors and/or components further introduce uncertainties in estimation of port-stay duration of vessels. Additionally, vessel type and different consignees may also introduce uncertainty and variations in handling cargos of vessels.

As port-stay duration, for example due to cargo loading/unloading operations at ports, is a critical factor impacting vessel turnaround time in addition to a vessel's voyage time between ports, accurate estimation of the port-stay duration of vessels is an important consideration for both ship and port operators. However, there is a lack of a method to accurately capture the key parameters affecting port operations, accurately learn the dynamic patterns in port operations, and/or predict accurate vessel port-stay duration.

A need therefore exists to provide a method and a system for predicting a port-stay duration of a vessel at a port that seeks to provide an accurate or improved prediction of port-stay duration for the vessel.

### SUMMARY

According to a first aspect of the present invention, there is provided a method for predicting a port-stay duration of a vessel at a port using at least one processor, the method comprising:
determining a plurality of port-stay components of the port-stay duration, the plurality of port-stay components comprising a first port-stay component and a plurality of second port-stay components;
determining a regression sequence of the plurality of port-stay components, comprising:
   modeling the first port-stay component to obtain a modeled first port-stay component, and modeling each of the plurality of second port-stay components to obtain a plurality of modeled second port-stay components,
   determining a relative measure associated to each of the plurality of second port-stay components by modeling each of the plurality of modeled second port-stay components based on a first criterion, and
   determining the regression sequence of the plurality of port-stay components based on the relative measure associated to each of the plurality of second port-stay components;
modeling each of the plurality of port-stay components in sequence in accordance with the regression sequence determined to obtain a first plurality of sequentially modeled port-stay components;
modeling a first port-stay duration based on the first plurality of sequentially modeled port-stay components to obtain a first port-stay duration model; and
predicting the port-stay duration based on the first port-stay duration model.

According to a second aspect of the present invention, there is provided a system for predicting a port-stay duration of a vessel at a port, the system comprising:
a memory; and
at least one processor communicatively coupled to the memory and configured to:
determine a plurality of port-stay components of the port-stay duration, the plurality of port-stay components comprising a first port-stay component and a plurality of second port-stay components;
determine a regression sequence of the plurality of port-stay components, comprising:
   modeling the first port-stay component to obtain a modeled first port-stay component, and modeling each of the plurality of second port-stay components to obtain a plurality of modeled second port-stay components,
   determining a relative measure associated to each of the plurality of second port-stay components by modeling each of the plurality of modeled second port-stay components based on a first criterion, and
   determining the regression sequence of the plurality of port-stay components based on the relative measure associated to each of the plurality of second port-stay components;
model each of the plurality of port-stay components in sequence in accordance with the regression sequence determined to obtain a first plurality of sequentially modeled port-stay components;
model a first port-stay duration based on the first plurality of sequentially modeled port-stay components to obtain a first port-stay duration model; and
predict the port-stay duration based on the first port-stay duration model.

According to a third aspect of the present invention, there is provided a computer program product, embodied in one or more non-transitory computer-readable storage mediums, comprising instructions executable by at least one processor to perform a method for predicting a port-stay duration of a vessel at a port, the method comprising:
determining a plurality of port-stay components of the port-stay duration, the plurality of port-stay components comprising a first port-stay component and a plurality of second port-stay components;
determining a regression sequence of the plurality of port-stay components, comprising:
   modeling the first port-stay component to obtain a modeled first port-stay component, and modeling each of the plurality of second port-stay components to obtain a plurality of modeled second port-stay components,
   determining a relative measure associated to each of the plurality of second modeled port-stay components by modeling each of the plurality of modeled second port-stay components based on a first criterion, and
   determining the regression sequence of the plurality of port-stay components based on the relative measure associated to each of the plurality of second port-stay components;
modeling each of the plurality of port-stay components in sequence in accordance with the regression sequence determined to obtain a first plurality of sequentially modeled port-stay components;
modeling a first port-stay duration based on the first plurality of sequentially modeled port-stay components to obtain a first port-stay duration model; and
predicting the port-stay duration based on the first port-stay duration model.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic flow diagram of a method for predicting a port-stay duration of a vessel at a port using at least one processor according to various embodiments of the present invention;

FIG. 2 depicts a schematic block diagram of a system for predicting a port-stay duration of a vessel at a port according to various embodiments of the present invention, such as corresponding to the method shown in FIG. 1;

FIG. 3 depicts an example computer system which the system according to various embodiments of the present invention may be embodied in;

FIG. 4 illustrates a diagram of exemplary port-stay components contributing to port-stay duration of a vessel;

FIG. 5 illustrates a diagram of a framework for predicting port-stay duration of a vessel according to various example embodiments of the present invention;

FIG. 6 illustrates a diagram of an exemplary workflow for an integrated adaptive model for predicting port-stay duration of a vessel, according to various example embodiments of the present invention;

FIG. 7 illustrates a berth planning/scheduling system, according to various example embodiments of the present invention;

FIGS. 8A to 8C illustrate a diagram of an exemplary scenario for berth planning/scheduling according to various example embodiments of the present invention;

FIG. 9 illustrates a diagram of a fleet management system according to various example embodiments of the present invention.

### DETAILED DESCRIPTION

Various embodiments of the present invention provide a method (computer-implemented method) and a system (including a memory and at least one processor communicatively coupled to the memory) for predicting a port-stay duration of a vessel at a port. In various embodiments, the port-stay duration of a vessel at a port may be a duration from the time when a vessel arrives at a port (or berth) until the time when the vessel leaves the port. In various embodiments, the port-stay duration of a vessel may be or include a duration for a loading/unloading operation of the vessel at the port. The loading/unloading operation of the vessel may include loading/unloading one or more cargos of the vessel. In some cases, the port-stay duration of a vessel may be the total time used for loading/unloading all the planned or intended cargos during a port-stay (or berth) of the vessel. It will be understood by a person skilled in the art that other types of operation and combination of operations in relation to a port-stay of a vessel are contemplated by the present invention.

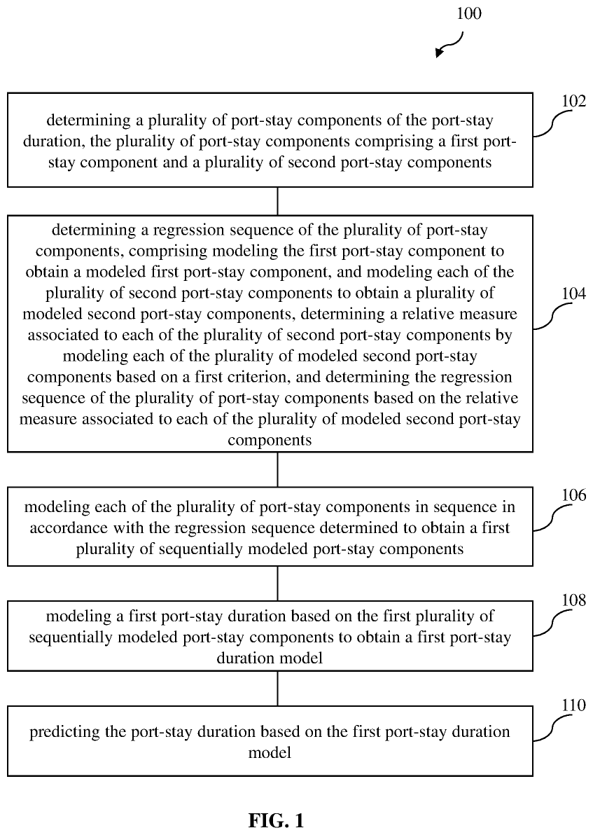

FIG. 1 depicts a schematic flow diagram of a method 100 (computer-implemented method) for predicting a port-stay duration (which may also interchangeably be referred to herein as a berth duration) of a vessel at a port using at least one processor according to various embodiments of the present invention. The method 100 comprises determining (at 102) a plurality of port-stay components of the port-stay duration, the plurality of port-stay components comprising a first port-stay component and a plurality of second port-stay components; determining (at 104) a regression sequence of the plurality of port-stay components, comprising modeling the first port-stay component to obtain a modeled first port-stay component, and modeling each of the plurality of second port-stay components to obtain a plurality of modeled second port-stay components, determining a relative measure associated to each of the plurality of second port-stay components by modeling each of the plurality of modeled second port-stay components based on a first criterion, and determining the regression sequence of the plurality of port-stay components based on the relative measure associated to each of the plurality of second port-stay components; modeling (at 106) each of the plurality of port-stay components in sequence in accordance with the regression sequence determined to obtain a first plurality of sequentially modeled port-stay components; modeling (at 108) a first port-stay duration based on the first plurality of sequentially modeled port-stay components to obtain a first port-stay duration model; and predicting (at 110) the port-stay duration based on the first port-stay duration model.

In relation to 102, for example, the plurality of port-stay components contribute to the duration in which a vessel stays (or berths) at a port of interest. In various embodiments, statistical analysis of the plurality of port-stay components may be performed to determine contribution of each port-stay component to port-stay duration of vessels at the port and the correlation between the plurality of port-stay components and port-stay duration of vessels at the port. The statistical analysis of the plurality of port-stay components may be performed using vessel data and port operation data.

In various embodiments, the vessel data and port operation data may include historical data as well as real-time data. The vessel data may include vessel information of vessels that have visited the port and/or are visiting the port as well as vessel information associated to the vessel of interest (e.g., vessel berth request time, vessel load, cargo information and so on). For example, the vessel data may be obtained from port call data. Other sources for obtaining the vessel data may also be appropriate. In a non-limiting example, the vessel data may include vessel information associated to vessels, such as but not limited to, vessel type, vessel deadweight, throughput of the vessel during a port-stay, cargo tonnage, cargo type, consignee, port of loading, berth time on request, etc. The port operation data may include operational information related to port operation at the port. In a non-limiting example, the port operation data may include operational information, such as but not limited to, loading/unloading facility and its handling rate, conveyor, stevedore, storage/silo, etc.

In relation to 104, for example, the regression sequence of the plurality of port-stay components may be a modeling sequence for modeling the plurality of port-stay components. By determining a regression sequence based on which each of the plurality of port-stay components may be modeled in sequence to predict the port-stay duration of a vessel at a port, the accuracy in predicting the port-stay duration of a vessel has been found to improve.

In various embodiments, the above-mentioned modeling the first port-stay component to obtain a modeled first port-stay component, and modeling each of the plurality of second port-stay components to obtain a plurality of modeled second port-stay components further comprises modeling each of the plurality of second port-stay components based on the modeled first port-stay component. For example, each of the plurality of second port-stay components may be modeled using values derived from (or estimated) from the modeled first port-stay component.

In relation to 104, for example, the relative measure associated to each of the plurality of second port-stay components may be determined by calculating relative measures of the respective plurality of modeled second port-stay components using the first criterion. In various embodiments, the first criterion is based on R-square. For example, the relative measure indicates a proportion of a variability of a modeled component that can be explained by a model which is used to model the component. In various embodiments, the relative measure associated to each of the plurality of second port-stay components indicates a proportion of a variability of each of the plurality of modeled second port-stay components modeled by at least one of the first modeled port-stay component and other modeled second port-stay components and one or more of a plurality of predefined port-stay factors.

In various embodiments, the above-mentioned determining the regression sequence of the plurality of port-stay components further comprises determining relationships among the plurality of second port-stay components based on a second criterion. For example, the relationships among the plurality of second port-stay components may be determined by modeling each of the plurality of second port-stay components by one or more of the plurality of predefined port-stay factors and other port-stay components (i.e., the first port-stay component and other second port-stay components of the plurality of second port-stay components). For example, determining the relationships among the plurality of second port-stay components based on the second criterion enables determining the proportion of each second port-stay component affected by the first port-stay component and other second port-stay components. In various embodiments, the second criterion may be a variable selection procedure such as Akaike information criterion, in a non-limiting example. In various embodiments, determining the regression sequence of the plurality of port-stay components is further based on the relationships among the plurality of second port-stay components. In various embodiments, related port-stay components may be selected based on the second criterion.

In various embodiments, the above-mentioned determining the regression sequence of the plurality of port-stay components comprises ordering the first port-stay component as having a first order in the regression sequence, followed by ordering the plurality of second port-stay components based on the relative measure associated to each of the plurality of second port-stay components. In various embodiments, the above-mentioned determining the regression sequence of the plurality of port-stay components based on the relative measure associated to each of the plurality of second port-stay components further comprises assigning a second port-stay component associated to a highest relative measure amongst the plurality of second port-stay components a first order amongst the plurality of second port-stay components in the regression sequence. For example, a second port-stay component associated with a highest R-square among the plurality of modeled second port-stay components is chosen or assigned the first order amongst the plurality of second port-stay components in the regression sequence (i.e., ordered as first amongst the plurality of second port-stay components in the regression sequence). Other unassigned second port-stay components of the plurality of second port-stay components (i.e., second port-stay components not assigned an order in the regression sequence yet) may be sequentially assigned orders in the regression sequence. In various embodiments, said determining the regression sequence of the plurality of port-stay components based on the relative measure associated to each of the plurality of second port-stay components further comprises modeling remaining second port-stay components of the plurality of second port-stay components based on one or more modeled second port-stay components having been assigned orders in the regression sequence, the modeled first port-stay component and one or more of a plurality of predefined port-stay factors. A further relative measure associated to each of the remaining second port-stay components may be further determined by modeling each of the modeled remaining second port-stay components of the plurality of second port-stay components based on the first criterion (e.g., R-square). The remaining second port-stay components may be sequentially assigned orders in the regression sequence based on whether they can be modeled by an immediate preceding port-stay component having been assigned an order in the regression sequence and one or more of the predefined plurality of port-stay factors. For example, a remaining second port-stay component of the plurality of second port-stay components may be assigned a second order amongst the plurality of second port-stay components in the regression sequence if it can be modeled by the port-stay component assigned with the first order and one or more of the predefined plurality of port-stay factors. If no unassigned port-stay component can be modeled by an immediate preceding port-stay component having been assigned an order in the regression sequence and one or more of the predefined plurality of port-stay factors, a remaining second port-stay component of the plurality of second port-stay components may be assigned a next order in the regression sequence if it is associated with the next highest (or biggest) R-square among the remaining second port-stay components of the plurality of second port-stay components.

In relation to 106, for example, a regression in sequence technique may be used for modeling each of the plurality of port-stay components in sequence to obtain a plurality of modeled port-stay components (or a first plurality of sequentially modeled port-stay components). The port-stay duration may be modeled using the first plurality of sequentially modeled port-stay components and one or more of the predefined plurality of port-stay factors to obtain a first port-stay duration model, and predicted by the first port-stay duration model.

In various embodiments, modeling (at 106 in FIG. 1) each of the plurality of port-stay components in sequence in accordance with the regression sequence determined to obtain a first plurality of sequentially modeled port-stay components comprises modeling the first port-stay component based on one or more of the plurality of predefined port-stay factors determined based on historical data to obtain a modeled first port-stay component of the first plurality of sequentially modeled port-stay components, and modeling, for each of the second port-stay components, the second port-stay component based on a factor derived from an immediate preceding modeled port-stay component of the first plurality of sequentially modeled port-stay components in the regression sequence and one or more of the plurality of predefined port-stay factors. The historical data based on which the plurality of predefined port-stay factors may be determined may include historical data of vessel data and port operation data. In various embodiments, one or more of the plurality of predefined port-stay factors selected to model each of the second port-stay component may be based on a stepwise variables selection procedure. In various embodiments, the factor derived from an immediate preceding modeled port-stay component, for example, may be fitted values (or estimated values) of the immediate preceding modeled port-stay component. In various embodiments, predicting the port-stay duration comprises predicting (or estimating) each of the plurality of port-stay components in sequence using the sequentially derived models. For example, the first port-stay component may be modeled by one or more of the plurality of predefined port-stay factors which is known, to obtain the estimated first port-stay component. Next, the second port-stay component may be estimated based on the estimated first port-stay component and one or more of the plurality of predefined port-stay factors. The remaining port-stay components of each of the plurality of port-stay components may be estimated in sequence in accordance with the regression sequence. After the last port-stay component is estimated, port-stay duration may be estimated based on the plurality of estimated port-stay components and one or more of the plurality of predefined port-stay factors.

In various embodiments, the first port-stay component is a working hour component, and modeling the first port-stay component comprises modeling the working hour component based on one or more of the plurality of predefined port-stay factors. In various embodiments, the plurality of second port-stay components are non-working hour components, and modeling the plurality of second port-stay components comprises modeling the non-working hour components based on the modeled working hour component and one or more of the plurality of predefined port-stay factors. A working hour component, for example, may be the proportion of time taken for a task-related event in relation to a port-stay of the vessel, while each non-working hour component may be the proportion of time for a non-task related event in relation to the port-stay of the vessel. For example, the non-working hour components may be associated with (or affected by) more uncertainties in relation to the port-stay of the vessel as compared to the working hour component.

In various embodiments, at least one of the plurality of second port-stay components is a weather-based non-working hour component. In various embodiments, modeling each of the plurality of port-stay components in sequence in accordance with the regression sequence determined to obtain a first plurality of sequentially modeled port-stay components comprises modeling each of the plurality of port-stay components including the weather-based non-working hour component in sequence. In various embodiments, the plurality of port-stay components may be further modeled in sequence in accordance with the regression sequence without the weather-based non-working hour component to obtain a second plurality of sequentially modeled port-stay components. A second port-stay duration may be modeled based on the second plurality of sequentially modeled port-stay components to obtain a second port-stay duration model. The port-stay duration may be further predicted using a weighted average determined based on the first port-stay duration model and second port-stay duration model.

In various embodiments, the weather-based non-working hour component may be modeled using historical data of non-working hours due to weather in a first time instance prior to arrival of the vessel. In various embodiments, the weather-based non-working hour component may be modeled using the historical data of non-working hours due to weather and weather forecast data in a second time instance prior to arrival of the vessel. In various embodiments, the first time instance may have a time period further away from arrival of the vessel relative to the second time instance.

In various embodiments, an end-to-end prediction system for port-stay duration may be advantageously implemented according to various embodiments of the present invention. The end-to-end prediction system may include a first module for predicting the port-stay duration and a second module for model training. In various embodiments, model parameters for model training may be updated periodically (e.g., every month). For example, a training data set may be updated (e.g., by adding in the latest month operation data to port operation data and vessel data) to enable learning of operation patterns at the port. In this regard, the learning model parameters may be automatically updated. This facilitates the prediction system in capturing dynamic patterns in port operations and providing accurate and robust prediction of port-stay duration ahead of each vessel call (e.g., one-month ahead).

Accordingly, various embodiments of the present invention advantageously provide a regression sequence based on which each of the plurality of port-stay components may be modeled in sequence to predict the port-stay duration of a vessel at a port. The prediction of port-stay duration of a vessel in accordance with the regression sequence advantageously provides an improved prediction of the port-stay duration (e.g., with higher accuracy). With an improved prediction of port-stay duration of vessels ahead of the arrival of vessels, for example, a ship operator may plan their fleet more efficiently while a port operator may also schedule its resources and berth allocation more efficiently. This results in higher productivity and promotes the coordination between ship and port operators. Further, the improved prediction of port-stay duration of vessels may facilitate an advanced berth booking system for allocating and booking berths for vessels in advance to avoid bunching and reduce demurrage cost.

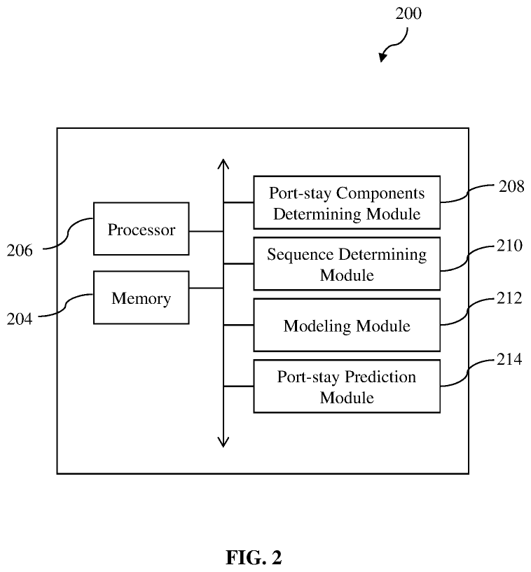

FIG. 2 depicts a schematic block diagram of a system 200 for predicting a port-stay duration of a vessel at a port according to various embodiments of the present invention, such as corresponding to the method 100 for predicting a port-stay duration of a vessel at a port as described hereinbefore according to various embodiments of the present invention.

The system 200 comprises a memory 204, and at least one processor 206 communicatively coupled to the memory 204 and configured to: determine a plurality of port-stay components of the port-stay duration, the plurality of port-stay components comprising a first port-stay component and a plurality of second port-stay components; determine a regression sequence of the plurality of port-stay components, comprising modeling the first port-stay component to obtain a modeled first port-stay component, and modeling each of the plurality of second port-stay components to obtain a plurality of modeled second port-stay components, determining a relative measure associated to each of the plurality of second port-stay components by modeling each of the plurality of modeled second port-stay components based on a first criterion, and determining the regression sequence of the plurality of port-stay components based on the relative measure associated to each of the plurality of second port-stay components; model each of the plurality of port-stay components in sequence in accordance with the regression sequence determined to obtain a first plurality of sequentially modeled port-stay components; modeling a first port-stay duration based on the first plurality of sequentially modeled port-stay components to obtain a first port-stay duration model; and predict the port-stay duration based on the first port-stay duration model.

It will be appreciated by a person skilled in the art that the at least one processor 206 may be configured to perform the required functions or operations through set(s) of instructions (e.g., software modules) executable by the at least one processor 206 to perform the required functions or operations. Accordingly, as shown in FIG. 2, the system 200 may further comprise a port-stay components determining module (or circuit) 208 configured to determine a plurality of port-stay components of the port-stay duration; a sequence determining module (or circuit) 210 configured to determine a regression sequence of the plurality of port-stay components; a modeling module (or circuit) 212 configured to model the plurality of port-stay components; and a port-stay prediction module (or circuit) 214 configured to predict the port-stay duration.

It will be appreciated by a person skilled in the art that the above-mentioned modules (or circuits) are not necessarily separate modules, and two or more modules may be realized by or implemented as one functional module (e.g., a circuit or a software program) as desired or as appropriate without deviating from the scope of the present invention. For example, the port-stay components determining module 208, the sequence determining module 210, the modeling module 212, and/or the port-stay prediction module 214 may be realized (e.g., compiled together) as one executable software program (e.g., software application or simply referred to as an “app”), which for example may be stored in the memory 204 and executable by the at least one processor 206 to perform the functions/operations as described herein according to various embodiments.

In various embodiments, the system 200 corresponds to the method 100 as described hereinbefore with reference to FIG. 1, therefore, various functions/operations configured to be performed by the least one processor 206 may correspond to various steps or operations of the method 100 described hereinbefore according to various embodiments, and thus need not be repeated with respect to the system 200 for clarity and conciseness. In other words, various embodiments described herein in context of the methods are analogously valid for the respective systems (e.g., which may also be embodied as devices).

For example, in various embodiments, the memory 204 may have stored therein the port-stay components determining module 208, the sequence determining module 210, the modeling module 212, and/or the port-stay prediction module 214, which respectively correspond to various steps or operations of the method 100 as described hereinbefore, which are executable by the at least one processor 206 to perform the corresponding functions/operations as described herein.

A computing system, a controller, a microcontroller or any other system providing a processing capability may be provided according to various embodiments in the present disclosure. Such a system may be taken to include one or more processors and one or more computer-readable storage mediums. For example, the system 200 described hereinbefore may include a processor (or controller) 206 and a computer-readable storage medium (or memory) 204 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof.Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code, e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “determining”, “modeling”, “predicting” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system (which may also be embodied as a device or an apparatus) for performing the operations/functions of the methods described herein. Such a system may be specially constructed for the required purposes, or may comprise a general purpose computer or other device selectively activated or reconfigured by a computer program stored in the computer. The algorithms presented herein are not inherently related to any particular computer or other apparatus. Various general-purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps or operations of the methods described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention. It will be appreciated by a person skilled in the art that various modules described herein (e.g., the port-stay components determining module 208, the sequence determining module 210, the modeling module 212, and/or the port-stay prediction module 214) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps or operations of a computer program/module or method described herein may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps or operations of the methods described herein.

In various embodiments, there is provided a computer program product, embodied in one or more computer-readable storage mediums (non-transitory computer-readable storage medium), comprising instructions (e.g., the port-stay components determining module 208, the sequence determining module 210, the modeling module 212, and/or the port-stay prediction module 214) executable by one or more computer processors to perform a method 100 for predicting a port-stay duration of a vessel at a port as described hereinbefore with reference to FIG. 1. Accordingly, various computer programs or modules described herein may be stored in a computer program product receivable by a system (e.g., a computer system or an electronic device) therein, such as the system 200 as shown in FIG. 2, for execution by at least one processor 206 of the system 200 to perform the required or desired functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

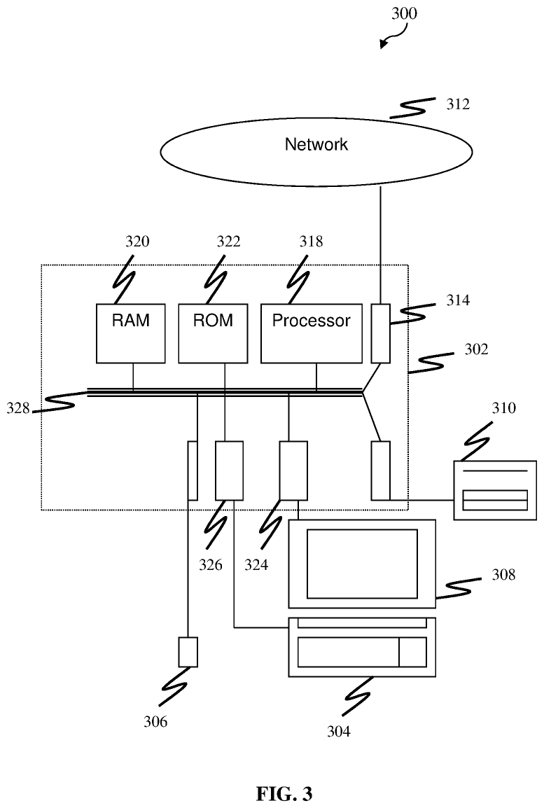

In various embodiments, the above-mentioned computer system may be realized by any computer system (e.g., portable or desktop computer system), such as a computer system 300 as schematically shown in FIG. 3 as an example only and without limitation. Various methods/operations or functional modules (e.g., the port-stay components determining module 208, the sequence determining module 210, the modeling module 212, and/or the port-stay prediction module 214) may be implemented as software, such as a computer program being executed within the computer system 300, and instructing the computer system 300 (in particular, one or more processors therein) to conduct the methods/functions of various embodiments described herein. The computer system 300 may comprise a computer module 302, input modules, such as a keyboard 304 and a mouse 306, and a plurality of output devices such as a display 308, and a printer 310. The computer module 302 may be connected to a computer network 312 via a suitable transceiver device 314, to enable access to e.g. the Internet or other network systems such as Local Area Network (LAN) or Wide Area Network (WAN). The computer module 302 in the example may include a processor 318 for executing various instructions, a Random Access Memory (RAM) 320 and a Read Only Memory (ROM) 322. The computer module 302 may also include a number of Input/Output (I/O) interfaces, for example I/O interface 324 to the display 308, and I/O interface 326 to the keyboard 304. The components of the computer module 302 typically communicate via an interconnected bus 328 and in a manner known to the person skilled in the relevant art.

It will be appreciated by a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise.

It will be further understood that the terms “comprises” and/or “comprising”, or the like such as “includes” and/or “including”, when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

In particular, for better understanding of the present invention and without limitation or loss of generality, various example embodiments of the present invention will now be described with respect to port-stay prediction of cement vessels for loading/unloading multiple cement cargos at a port of interest. However, it will be appreciated by a person skilled in the art that the present invention is not limited to cement vessels loading/unloading cement cargos at the port, and the method for predicting a port-stay duration of a vessel at a port as disclosed herein according to various embodiments may be applied to predict the port-stay duration of various other types of vessels for other vessel related task/operations at the port.

In various example embodiments, a port-stay duration of a vessel at a port of interest may be contributed by a plurality of port-stay components. For example, in the case where an operation (or main operation) of the vessel includes loading/unloading multiple (or a plurality of) cargos at the port, the port-stay duration of the vessel may be the total time used for loading/unloading all the cargos of the vessel. The time used for loading/unloading each cement cargo may be its gross working hours (GWH). Accordingly, a sum of all the GWH for loading/unloading all the cargos of the vessel may be the vessel's port-stay duration. In various example embodiments, the GWH for each cargo may be contributed by the plurality of port-stay components. In various embodiments, the plurality of port-stay components may include a first port-stay component and a plurality of second port-stay components. In various embodiments, the first port-stay component may be a working hour (NWH) component and the plurality of second port-stay components may be non-working hour components.

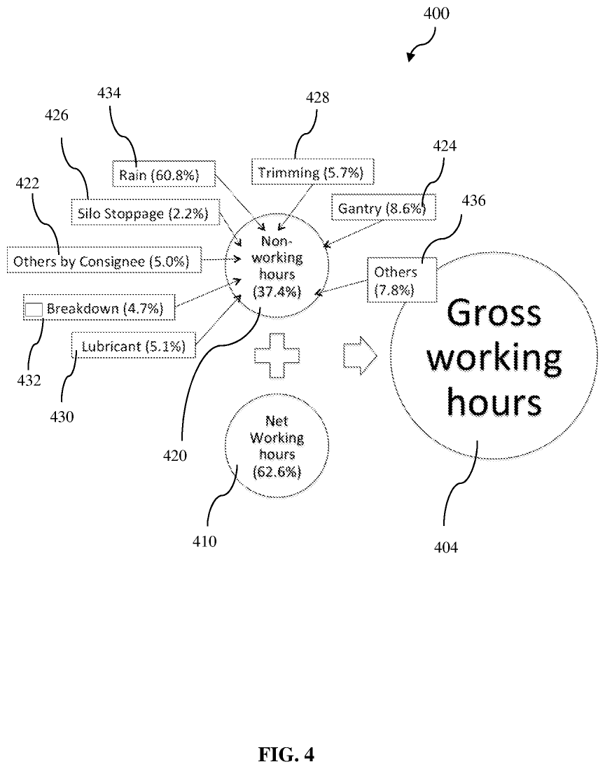

FIG. 4 illustrates a diagram of exemplary port-stay components 400 contributing to port-stay duration of a vessel. For example, a plurality of port-stay components as illustrated contributes to a GWH 404 or time for loading/unloading each cargo of the vessel. In other words, the plurality of port-stay components contribute to the port-stay duration of the vessel.

In various example embodiments, the plurality of port-stay components may include a working hour component 410 and non-working hour components 420. In a non-limiting example, the non-working hour components 420 may include a consignee component 422, a gantry time (SHF) component 424, a silo stoppage time (SIL) component 426, a trimming component 428, a lubrication (LUB) component 430, a breakdown and maintenance (OTJ) component 432, a weather based non-working hour component 434, and an exceptional cases (OTH) component 436. For example, the consignee component 422, the gantry time (SHF) component 424 and the silo stoppage time (SIL) component 426 may be due to consignees, the trimming component 428 may be due to engagement of stevedore, the lubrication (LUB) component 430 and the breakdown and maintenance (OTJ) component 432 may be due to port operations, the weather based non-working hour component 434 may be due to rain, while the exceptional cases (OTH) component 436 may be due to other miscellaneous events/situations. Although nine port-stay components are illustrated, it is understood that there may be other numbers or types of port-stay components contributing to port-stay duration other than those associated to loading/unloading cargos (such as cement cargos) of a vessel.

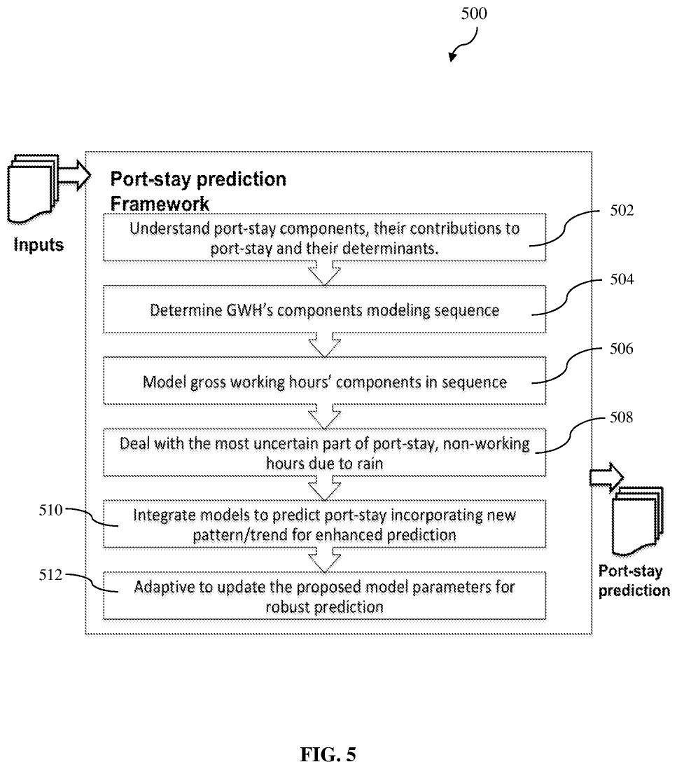

FIG. 5 illustrates a diagram of a framework 500 for predicting port-stay duration of a vessel according to various example embodiments of the present invention. For example, the framework may be a port-stay prediction framework. The port-stay prediction framework includes, at 502, determining a plurality of port-stay components, their contributions to port-stay duration and their determinants. In various example embodiments, statistical analysis of the plurality of port-stay components contributing to the port-stay duration may be performed to determine contribution of each port-stay component to the port-stay duration and the correlation between the port-stay components and the port-stay duration. For example, statistical analysis of the plurality of port-stay components contributing to each cargo's gross working hours is performed to determine contribution of each port-stay component to the gross working hours and the correlation between the port-stay components and the gross working hours. In various example embodiments, relationships between port operation and one or more of a plurality of predefined port-stay factors may be determined to identify key parameters affecting port-stay duration.

In various example embodiments, a plurality of predefined port-stay factors which may affect port-stay duration of the vessel may be determined. Table 1 shows exemplary plurality of predefined port-stay factors as follows:

TABLE 1
Port-stay factors

| | | | | | |
|---|---|---|---|---|---|
| | Vessel | | | Berth time | Port of |
| Vessel | deadweight | Cement | Unloader | on request | loading |
| level factors | (vsldeadwtton) | throughput | (ul) | (btr) | (pol) |

| | | | | |
|---|---|---|---|---|
| Cargo | Consignee | Cargo tonnage | Cargo type | Stevedore |
| level factors | | | | |

In various example embodiments, the plurality of predefined port-stay factors which may affect port-stay duration of the vessel may be determined based on vessel data and port operation data. In various example embodiments, the plurality of predefined port-stay factors may be determined based on historical vessel data and historical port operation data.

In various example embodiments, the statistical analysis of the plurality of port-stay components may be based on derivatives of one or more of the plurality of predefined port-stay factors to better capture and reflect their non-linear impact on port-stay duration.

For example, the derivatives of one or more of the plurality of predefined port-stay factors may include a square term, a cube term, a logarithm, and/or ratios among relevant predefined port-stay factors. In a non-limiting example, the derivatives of one or more of the plurality of predefined port-stay factors may include: transformation of cargo tonnage including square term, cube term and logarithm for capturing non-linear impact of cargo tonnage to port-stay duration; transformation of berth time of request to explore nonlinear port-stay trend through its square term, cube term and natural splines; ratio of throughput to vessel deadweight to explore the impact of vessel occupation degree; ratio of cargo tonnage to throughput to explore the impact of the proportion of cargo in whole throughput; ratio of cargo tonnage to vessel deadweight; and derivatives of vessel cargo (e.g., an indicator to represent if the cargo types are different and if the cargos are from different consignee).

Table 2 shows exemplary derivatives of one or more of the plurality of predefined port-stay factors as follows:

TABLE 2
Derivatives of one or more of the plurality of predefined port-stay factors

| | | | | |
|---|---|---|---|---|
| I | Ratio of cement | Ratio of cargo tonnage | Ratio of cargo | vessel_cargo |
| | throughput to deadweight | to cement throughput | tonnage to deadweight | |
| | (ceth_dw_ratio) | (cato_ceth_ratio) | (cato_dw_ratio) | |
| II | Natural spline of BTR | Cargotonnage | | |
| | (btr.ns) | (square, cube, logarithm) | | |

For example, by performing the statistical analysis of the plurality of port-stay components based on the derivatives of one or more of the plurality of predefined port-stay factors, the non-linear impact of the predefined port-stay factors on the working hour component may be considered, which further improves the prediction accuracy.

In various example embodiments, at 504, the framework includes determining a regression sequence of the plurality of port-stay components. For example, a regression sequence of the plurality of port-stay components of the GWH may be determined. In various example embodiments, determining the regression sequence of the plurality of port-stay components includes modeling the working hour (NWH) component (or first port-stay component) using one or more of the plurality of predefined port-stay factors to obtain a modeled working hour component. For example, estimated values may be determined from the modeled working hour component. Next, determining the regression sequence of the plurality of port-stay components includes modeling each of the non-working hour components (or plurality of second port-stay components) by the modeled working hour component (or estimated values of the working hour component) and one or more of the plurality of predefined port-stay factors to obtain modeled non-working hour components.

In various example embodiments, each of the modeled non-working hour components may be modeled based on R-square (first criterion) to determine the proportion of each modeled non-working hour components that can be explained by a model used to model the respective non-working hour component. For example, R-square measures a goodness of fit of a modeled component. It is also the proportion of the variability of the component explained by the model used to model the component. For example,

$${R}^{2} = 1 - \frac{\sum {( \hat{y} - y )}^{2}}{\sum {( y - \overline{y} )}^{2}} ,$$

wherein y is an observed value of the component, ŷ is the corresponding estimated value of the component, and y̅ is the average of the observed value. The denominator indicates the variability of the component, while the nominator indicates model error. In various example embodiments, relationships among the non-working hour components may be determined to identify related non-working hour components. The relationships among the non-working hour components may be determined by modeling each non-working hour component by one or more of the plurality of predefined port-stay factors and other components (i.e., working hour component and other non-working hour components). In various example embodiments, related non-working hour components may be selected based on a variable selection procedure. In various example embodiments, the related non-working hour components may be selected based on Akaike information criterion.

In various example embodiments, the regression sequence of the non-working hour components may be determined based on the proportion of a modeled component that can be explained, and how other components contribute to that modeled component (e.g., modeled non-working hour component being evaluated). In an example determination of the regression sequence, each of the non-working hour components may first be modeled by other non-working hour components, the modeled working hour component and one or more of the plurality of predefined port-stay factors. Next, a plurality of final variables used for modeling each of the non-working hour components may be determined by a stepwise variables selection procedure. Other non-working hour components which are selected in the plurality of final variables are determined and recorded. A non-working hour component that can be modeled without other non-working hour components is determined (or identified). In the case that a non-working hour component that can be modeled without other non-working hour components cannot be found, each of the non-working hour components may then be modeled by the modeled working hour component and the plurality of predefined port-stay factors. Each of the non-working hour components modeled by the modeled working hour component and the plurality of predefined port-stay factors may then be modeled based on R-square (first criterion) and recorded. For example, in the case modeling the SHF component is associated with the highest (or biggest) R-square value, the SHF component may be the first non-working hour component selected to be modeled (i.e., assigned a first order among the non-working hour components in the regression sequence). After the SHF component is selected, a next non-working hour component that can be modeled only by the SHF component without other non-working hour components is determined. In the case that a next non-working hour component that can be modeled only by the SHF component without other non-working hour components cannot be found, the remaining non-working hour components are modeled by the modeled SHF component, the modeled working hour component and one or more of the plurality of predefined port-stay factors. Each of the remaining non-working hour components modeled by the modeled SHF component, the modeled working hour component and one or more of the plurality of predefined port-stay factors may then be modeled based on R-square (first criterion) and recorded. For example, in the case modeling the LUB component is associated with the highest (or biggest) R-square value among the remaining non-working hour components, the LUB component may be the next (or second) non-working hour component selected to be modeled (i.e., assigned a second order among the non-working hour components in the regression sequence). In various example embodiments, the LUB component and the SHF component may be selected to model a next remaining non-working hour components (e.g., OTJ component, OTH component, and so forth). For example, the LUB component and the SHF component may be the only two non-working hour components selected to model a next remaining non-working hour components. The next remaining non-working hour components may be modeled by the modeled LUB component, the modeled SHF component, the modeled working hour component and one or more of the plurality of predefined port-stay factors. The next remaining non-working hour components associated with a highest R-square may be selected as next non-working hour component to be modeled. As the selection procedure continues, the next remaining non-working hour components are selected in sequence and modeled. For example, a regression in sequence technique is used to determine the regression sequence of the port-stay components.

In various example embodiments, at 506, the framework includes modeling each of the plurality of port-stay components in sequence in accordance with the regression sequence determined to obtain a plurality of modeled port-stay components (first plurality of sequentially modeled port-stay components) based on which the port-stay duration of a vessel may be predicted. In various example embodiments, the working hour (NWH) component may be assigned a first order in the regression sequence. The NWH component may be modeled by one or more of the plurality of predefined port-stay factors. In various example embodiments, after the NWH component is modeled, its fitted value may be used as a new (or derived) factor to model and/or estimate the non-working hour components. For example, the actual or observed values of the NWH component and one or more of the plurality of predefined port-stay factors may be used to build a model of the NWH component and estimate the model's coefficients. The estimated model coefficients and the observed plurality of predefined port-stay factors are incorporated to the model to estimate the NWH component. For example, after the NWH component is modeled, the NWH component is estimated based on the model and one or more of the plurality of predefined port-stay factors. The estimated NWH component may also be called a fitted value of the NWH component. For modeling and/or estimating each of the non-working hour components, the non-working hour component may be modeled based on a factor derived from an immediate preceding modeled port-stay component in the regression sequence and one or more of the plurality of predefined port-stay factors. For example, a non-working hour component to be modeled first in accordance with the regression sequence may be modeled by a factor derived from the modeled NWH component and one or more of the plurality of predefined port-stay factors. For example, the factor derived from the modeled NWH component may be its fitted value. After the non-working hour component is modeled, its fitted value is considered as a new factor for the modeling the remaining non-working hour components. The procedure continues until all non-working hour components are modeled. In various example embodiments, the one or more of the plurality of predefined port-stay factors selected for modeling the working hour component and each non-working hour component are based on stepwise variables selection procedure.

In various example embodiments, at 508, the framework incorporates different models to deal with uncertain port-stay components contributing to port-stay duration. In various example embodiments, a first stage model and a second stage model may be employed to model the weather-based non-working hour component. In various example embodiments, the weather-based non-working hour component may be or include non-working hour due to rain (RNS) associated to vessels. For example, the non-working hour due to rain (RNS) explains (or contributes) most to non-working hours of vessels. However, it is difficult to estimate RNS as rain frequency and duration cannot be accurately forecasted, for example, one month ahead prior to arrival of a vessel. Accordingly, the first stage model and the second stage model advantageously takes into account uncertainty of the weather-based non-working hour component to predict port-stay duration of a vessel.

In various example embodiments, the first stage model for modeling the weather-based non-working hour component uses historical data of non-working hours due to weather (e.g., non-working hours due to rain). For example, the historical data of non-working hours due to weather may be historical median RNS based on monthly season to estimate RNS for each vessel. The first stage model for modeling the weather-based non-working hour component may be developed in a first time instance prior to arrival of a vessel. For example, the first time instance may be one month before the berth request date of a vessel.

In various example embodiments, the second stage model for modeling the weather-based non-working hour component uses weather forecast data and the historical data of non-working hours due to weather. The second stage model for modeling the weather-based non-working hour component may be developed in a second time instance prior to arrival of the vessel. For example, the second time instance may be n-days ahead prior to arrival of the vessel. For example, the second stage model incorporates n-days ahead weather forecast data. The weather forecast data may be a rain forecast, for example. The weather forecast data may be obtained, for example, from a weather forecast site. Accordingly, as time approaches the berth request date of a vessel, the second stage model is used for modeling the weather-based non-working hour component. This advantageously enhances accuracy of the prediction of port-stay duration and enables the prediction output to be updated as the time to vessel arrival approaches. For example, an n-days rain duration forecasting is captured and used to further estimate RNS and provide a more accurate prediction of port-stay duration, which may be used to inform consignees about the loading/unloading time required and enable vessel operators to update the arrangement for a next voyage.

In various example embodiments, at 510, the framework integrates a plurality of models to predict port-stay duration. The plurality of models may incorporate new pattern/trend for enhanced prediction of port-stay duration. In various embodiments, the plurality of models include first, second, third and fourth sub-models to predict port-stay duration which considers different aspects to deal with RNS and different model patterns in different time periods. For example, the first sub-model (first port-stay duration model) models gross working hours on all port-stay components except for RNS, for each cargo. The first sub-model may be referred to as Gross Working Hours (GWH_w_rain). In the first sub-model, the GWH may be modeled by the modeled NWH component, non-working hour components and one or more of the plurality of predefined port-stay factors. The final variables selected are determined by the stepwise variables selection procedure. After modeling, the first sub-model may be estimated. The prediction of the port-stay duration may be a sum of all cargos' estimated GWH based on the first sub-model. In relation to the second sub-model (second port-stay duration model), it considers Gross Working Hours excluding RNS (GWH_wo_rain). In the second sub-model, the GWH excluding rain may be modeled by modeled NWH, non-working hour components and one or more of the plurality of predefined port-stay factors (e.g., GWH may be modeled without the weather-based non-working hour component). The final variables selected are determined by the stepwise variables selection procedure. After modeling, the second sub-model may be estimated. The prediction of the port-stay duration may be a sum of all cargos' estimated GWH based on the second sub-model and estimated non-working hour due to rain (RNS_est). For example, the third sub-model may be similar to the first sub-model but considers different phases of data, while the fourth sub-model may be similar to the second sub-model but considers different phases of data. The port-stay duration may be predicted or estimated based on a weighted average of the first, second, third and fourth sub-models. In various example embodiments, a long-term trend may be represented by a natural spline function.

In various example embodiments, at 512, model parameters used in modeling the port-stay component may be updated periodically to capture new trend. For example, the parameters may be updated at a monthly frequency. Other time periods may also be useful. Accordingly, a self-learning model may be updated automatically which captures changes in port operation. This advantageously provides an adaptive self-learning model for predicting the port-stay duration, which enables robust and accurate predictions.

Accordingly, the present framework provides an enhanced solution for predicting vessel port-stay duration by automatically capturing the dynamic operation patterns, handling the most uncertain portion contributing to port-stay duration (e.g., non-working hour due to rain), utilizing weather forecast data to update prediction outputs, and incorporating a self-learning model which updates model parameters to capture operation trends.

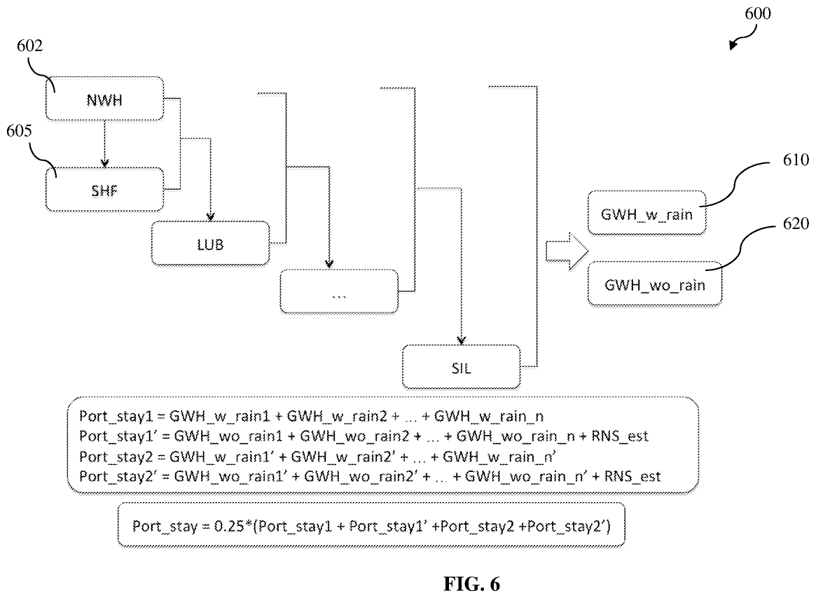

FIG. 6 illustrates a diagram of an exemplary workflow 600 for an integrated adaptive model for predicting port-stay duration of a vessel, according to various example embodiments of the present invention. As shown, the workflow includes modeling each of the plurality of port-stay components in sequence in accordance with the regression sequence determined to obtain a plurality of modeled port-stay components (e.g., first plurality of sequentially modeled port-stay components). For example, the working hour component 602 may be first modeled. A first non-working hour component 605 may be modeled based on the working-hour component 602. The remaining non-working hour component may be modeled based on an immediate preceding modeled non-working hour component in the regression sequence. In an example, a first port-stay duration may be modeled based on the first plurality of sequentially modeled port-stay components to obtain a first port-stay duration model 610. In another example, a second port-stay duration may be modeled based on a second plurality of sequentially modeled port-stay components to obtain a second port-stay duration model 620. The port-stay duration may be predicted based on the modeled port-stay durations (e.g., first port-stay duration model and the second port-stay duration model).

It has been observed that the prediction of port-stay duration according to the present framework may achieve an accuracy which is about 28% (=100%(1-20.62/28.62)) higher than conventional methods. Table 3 shows an exemplary test comparison of predictions for cement vessels according to various example embodiments of the present invention (the various example embodiments may herein be referred to as the present framework) and a conventional method as follows:

TABLE 3
Test comparison of prediction for cement vessels using present
framework and a conventional method (April-May, 33 vessels)

| | | Number of predictions |
|---|---|---|
| | | associated with |
| Total absolute prediction error | | better performance |
| Prediction using | Prediction using | (conventional method |
| conventional method | present framework | vs present framework) |
| 28.62 | 20.62 | 9:21 (30%:70%) |

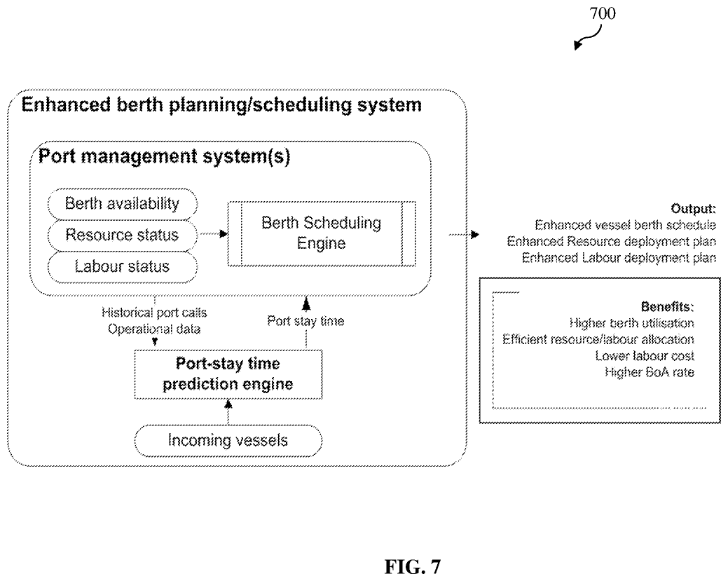

The predictions of port-stay duration according to various example embodiments demonstrate higher accuracy as compared to conventional methods. For example, based on the tested vessels, 70% of the predictions using the method according to embodiments of the present invention show better accuracy. For example, the present framework may be integrated into various planning and management systems of port or vessel operators. FIG. 7 illustrates a berth planning/scheduling system 700 that takes into consideration the berth, resource and labour availability while the accuracy of the berth schedule may be increased by incorporating the port-stay duration prediction framework as an intelligent engine, which can adaptively learn the past operation and weather patterns for prediction. This advantageously results in an increased berth on arrival (BoA) rate that is critical for higher customer service level.

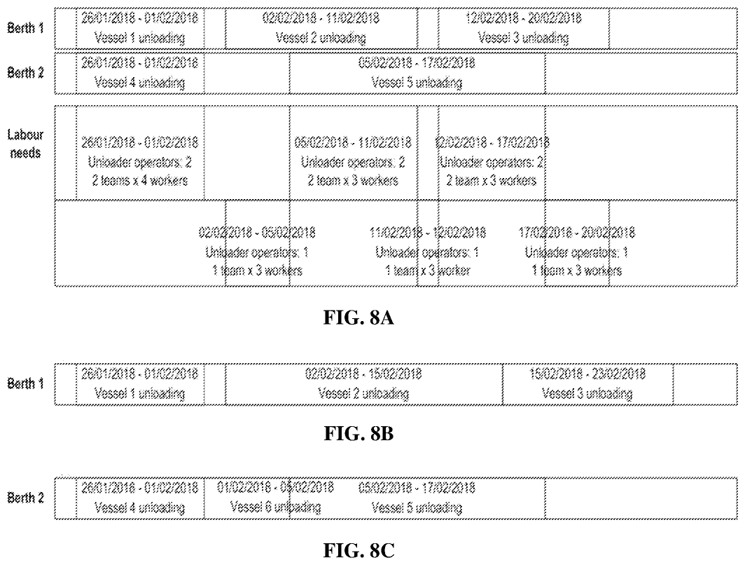

FIGS. 8A to 8C illustrate a diagram of an exemplary scenario for berth planning/scheduling according to various example embodiments. For example, five vessels are scheduled to carry out the loading/unloading process on berths 1 and 2 respectively. The labour needs or other resources such as unloader, conveyor and silo balance can be worked out based on the berth schedule. The labour and resource planning and deployment are derived from the berth schedule and their availabilities. The berth schedule without accurate prediction of port-stay duration may cause uncertainty, surplus or insufficiency in labour and resource planning and allocation and lead to lower efficiency. If the actual berth time of Vessel 2 is not predicted accurately, i.e., it is actually much longer than scheduled in FIG. 8A, it not only causes the delay of the berthing of Vessel 3 as shown in FIG. 8B, which eventually decreases the BoA rate, but also affects all the relevant resource and labour plan and allocation. However, in the case where an operator is confident in the schedule arrangement supported with the accurate prediction of port-stay duration, he or she could arrange one more vessel, (e.g., Vessel 6) which nicely takes the 3-day slot, between Vessel 4 and Vessel 5, as shown in FIG. 8C.

Accordingly, it is advantageous to have an improved or accurate prediction of port-stay duration that is able to enhance operation efficiency through reducing the variations between scheduled berth time and actual berth time. For example, a more accurate port-stay duration/berth time results in better schedule, which facilitates more accurate labour and resource planning, improving operation efficiency, and enhancing service level in ports. Furthermore, as long as vessels arrive in time according to the berth schedule, they are able to be berthed with minimal delay, which increases the BoA rate.

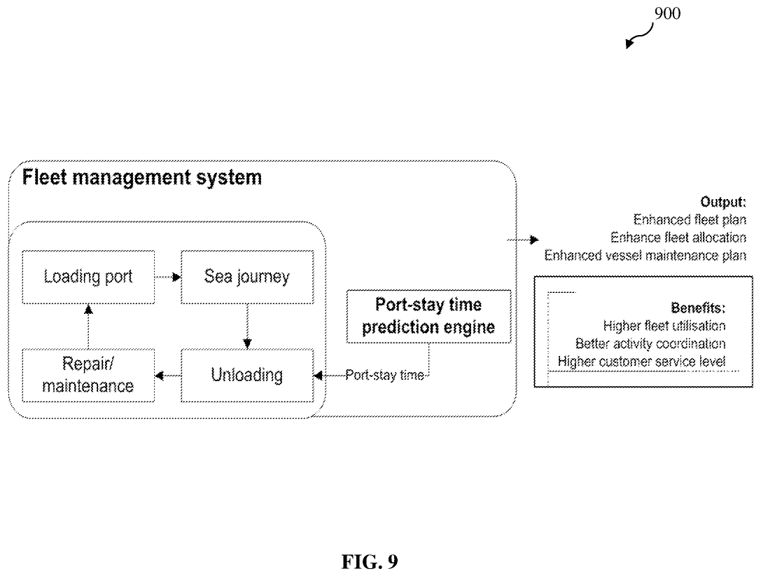

FIG. 9 illustrates a diagram of a fleet management system 900 according to various example embodiments of the present invention. For example, the fleet management system 900 incorporates the port-stay prediction framework. For example, the port-stay prediction framework advantageously enables a vessel operator to plan its fleet with more confidence in time taken for cargo unloading/loading operation based on a more accurate prediction of port-stay duration. Accordingly, other vessel activities such as bunkering and receiving food supply may also be scheduled properly with less last-minute changes. With an accurate prediction of port-stay duration, a vessel may also plan its voyage and take its next order timely with reduced empty trips and higher customer service level.

While embodiments of the invention have been particularly shown and described with reference to specific embodiments, it should be understood by those skilled in the art that various changes in form and detail may be made therein without departing from the scope of the invention as defined by the appended claims. The scope of the invention is thus indicated by the appended claims and all changes which come within the meaning and range of equivalency of the claims are therefore intended to be embraced.

What is claimed is:

1. A computer-implemented method for predicting a port-stay duration of a vessel at a port using at least one processor, the method comprising:
determining a plurality of port-stay components of the port-stay duration, the plurality of port-stay components comprising a first port-stay component and a plurality of second port-stay components;
determining a regression sequence of the plurality of port-stay components, comprising:
modeling the first port-stay component to obtain a modeled first port-stay component, and modeling each of the plurality of second port-stay components to obtain a plurality of modeled second port-stay components,
determining a relative measure associated to each of the plurality of second port-stay components by modeling each of the plurality of modeled second port-stay components based on a first criterion, and
determining the regression sequence of the plurality of port-stay components based on the relative measure associated to each of the plurality of second port-stay components;
modeling each of the plurality of port-stay components in sequence in accordance with the regression sequence determined to obtain a first plurality of sequentially modeled port-stay components;
modeling a first port-stay duration based on the first plurality of sequentially modeled port-stay components to obtain a first port-stay duration model; and
predicting the port-stay duration based on the first port-stay duration model.

2. The method of claim 1, wherein the relative measure indicates a proportion of a variability of each of the plurality of modeled second port-stay components modeled by at least one of the first modeled port-stay component and other modeled second port-stay components and one or more of a plurality of predefined port-stay factors.

3. The method of claim 1, wherein the first criterion is based on R-square.

4. The method of claim 1, wherein said determining the regression sequence of the plurality of port-stay components based on the relative measure associated to each of the plurality of second port-stay components further comprises assigning a second port-stay component associated to a highest relative measure amongst the plurality of second port-stay components a first order amongst the plurality of second port-stay components in the regression sequence.

5. The method of claim 1, wherein said modeling the first port-stay component to obtain a modeled first port-stay component, and modeling each of the plurality of second port-stay components to obtain a plurality of modeled second port-stay components further comprises modeling each of the plurality of second port-stay components based on the modeled first port-stay component.

6. The method of claim 1, wherein said modeling each of the plurality of port-stay components in sequence in accordance with the regression sequence comprises:
modeling the first port-stay component based on one or more of a plurality of predefined port-stay factors determined based on historical data to obtain a modeled first port-stay component of the first plurality of sequentially modeled port-stay components; and
modeling, for each of the plurality of second port-stay components, the second port-stay component based on a factor derived from an immediate preceding modeled port-stay component of the first plurality of sequentially modeled port-stay components in the regression sequence and one or more of the plurality of predefined port-stay factors.

7. The method of claim 1, wherein said determining the regression sequence of the plurality of port-stay components further comprises:
determining relationships among the plurality of second port-stay components based on a second criterion, and
determining the regression sequence of the plurality of port-stay components based on the relationships among the plurality of second port-stay components.

8. The method of claim 1, wherein:
the first port-stay component is a working hour component, and modeling the first port-stay component comprises modeling the working hour component based on one or more of a plurality of predefined port-stay factors; and
the plurality of second port-stay components are non-working hour components, and modeling the plurality of second port-stay components comprises modeling the non-working hour components based on the modeled working hour component and one or more of the plurality of predefined port-stay factors.

9. The method of claim 1, wherein:
at least one of the plurality of second port-stay components is a weather-based non-working hour component, and modeling each of the plurality of port-stay components in sequence in accordance with the regression sequence determined to obtain the first plurality of sequentially modeled port-stay components comprises modeling each of the plurality of port-stay components including the weather-based non-working hour component in sequence, and further comprising:
modeling the plurality of port-stay components in sequence in accordance with the regression sequence without the weather-based non-working hour component to obtain a second plurality of sequentially modeled port-stay components;
modeling a second port-stay duration based on the second plurality of sequentially modeled port-stay components to obtain a second port-stay duration model; and
predicting the port-stay duration using a weighted average determined based on the first port-stay duration model and second port-stay duration model.

10. The method of claim 1:
wherein at least one of the plurality of second port-stay components is a weather-based non-working hour component; and
further comprising modeling the weather-based non-working hour component using historical data of non-working hours due to weather in a first time instance prior to arrival of the vessel, and modeling the weather-based non-working hour component using the historical data of non-working hours due to weather and weather forecast data in a second time instance prior to arrival of the vessel, the first time instance having a time period further away from arrival of the vessel relative to the second time instance.

11. A system for predicting a port-stay duration of a vessel at a port, the system comprising:
a memory; and
at least one processor communicatively coupled to the memory and configured to:
determine a plurality of port-stay components of the port-stay duration, the plurality of port-stay components comprising a first port-stay component and a plurality of second port-stay components;
determine a regression sequence of the plurality of port-stay components, comprising:
modeling the first port-stay component to obtain a modeled first port-stay component, and modeling each of the plurality of second port-stay components to obtain a plurality of modeled second port-stay components,
determining a relative measure associated to each of the plurality of second port-stay components by modeling each of the plurality of modeled second port-stay components based on a first criterion, and
determining the regression sequence of the plurality of port-stay components based on the relative measure associated to each of the plurality of second port-stay components;
model each of the plurality of port-stay components in sequence in accordance with the regression sequence determined to obtain a first plurality of sequentially modeled port-stay components;
model a first port-stay duration based on the first plurality of sequentially modeled port-stay components to obtain a first port-stay duration model; and
predict the port-stay duration based on the first port-stay duration model.

12. The system according to claim 11, wherein the relative measure indicates a proportion of a variability of each of the plurality of modeled second port-stay components modeled by at least one of the first modeled port-stay component and other modeled second port-stay components and one or more of a plurality of predefined port-stay factors.

13. The system according to claim 11, wherein said determine the regression sequence of the plurality of port-stay components based on the relative measure associated to each of the plurality of modeled second port-stay components further comprises assigning a second port-stay component associated to a highest relative measure amongst the plurality of second port-stay components a first order amongst the plurality of modeled second port-stay components in the regression sequence.

14. The system according to claim 11, wherein said modeling the first port-stay component to obtain a modeled first port-stay component, and modeling each of the plurality of second port-stay components to obtain a plurality of modeled second port-stay components further comprises modeling each of the plurality of second port-stay components based on the modeled first port-stay component.

15. The system according to claim 11, wherein said model each of the plurality of port-stay components in sequence in accordance with the regression sequence comprises:
modeling the first port-stay component based on one or more of a plurality of predefined port-stay factors determined based on historical data to obtain a modeled first port-stay component of the first plurality of sequentially modeled port-stay components; and
modeling, for each of the plurality of second port-stay components, the second port-stay component based on a factor derived from an immediate preceding modeled port-stay component of the first plurality of sequentially modeled port-stay components in the regression sequence and one or more of the plurality of predefined port-stay factors.

16. The system according to claim 11, wherein said determine the regression sequence of the plurality of port-stay components further comprises:
determining relationships among the plurality of second port-stay components based on a second criterion, and
determining the regression sequence of the plurality of port-stay components based on the relationships among the plurality of second port-stay components.

17. The system according to claim 11, wherein:
the first port-stay component is a working hour component, and modeling the first port-stay component comprises modeling the working hour component based on one or more of a plurality of predefined port-stay factors; and
the plurality of second port-stay components are non-working hour components, and modeling the plurality of second port-stay components comprises modeling the non-working hour components based on the modeled working hour component and one or more of the plurality of predefined port-stay factors

18. The system according to claim 11, wherein:
at least one of the remaining port-stay components is a weather-based non-working hour component, and
model each of the plurality of port-stay components in sequence in accordance with the regression sequence determined to obtain a first plurality of sequentially modeled port-stay components comprises modeling each of the plurality of port-stay components including the weather-based non-working hour component in sequence; and the at least one processor is further configured to
model the plurality of port-stay components in sequence in accordance with the regression sequence without the weather-based non-working hour component in sequence to obtain a second plurality of sequentially modeled port-stay components;
model a second port-stay duration based on the second plurality of sequentially modeled port-stay components to obtain a second port-stay duration model; and
predict the port-stay duration using a weighted average determined based on the first port-stay duration model and second port-stay duration model.

19. The system according to claim 11, wherein:
at least one of the plurality of second port-stay components comprise a weather-based non-working hour component, and the at least one processor is further configured to
model the weather-based non-working hour component using historical data of non-working hours due to weather in a first time instance prior to arrival of the vessel, and model the weather-based non-working hour component using the historical data of non-working hours due to weather and weather forecast data in a second time instance prior to arrival of the vessel, the first time instance having a time period further away from arrival of the vessel relative to the second time instance.

20. A computer program product, embodied in one or more non-transitory computer-readable storage mediums, comprising instructions executable by at least one processor to perform a method for predicting a port-stay duration of a vessel at a port, the method comprising:
determining a plurality of port-stay components of the port-stay duration, the plurality of port-stay components comprising a first port-stay component and a plurality of second port-stay components;
determining a regression sequence of the plurality of port-stay components, comprising:
modeling the first port-stay component to obtain a modeled first port-stay component, and modeling each of the plurality of second port-stay components to obtain a plurality of modeled second port-stay components,
determining a relative measure associated to each of the plurality of second port-stay components by modeling each of the plurality of modeled second port-stay components based on a first criterion, and
determining the regression sequence of the plurality of port-stay components based on the relative measure associated to each of the plurality of second port-stay components;
modeling each of the plurality of port-stay components in sequence in accordance with the regression sequence determined to obtain a first plurality of sequentially modeled port-stay components;
modeling a first port-stay duration based on the first plurality of sequentially modeled port-stay components to obtain a first port-stay duration model; and
predicting the port-stay duration based on the first port-stay duration model.
